(19) United States
(12) Patent Application Publication
(10) Pub. No.: US 2007/0073623 A1
(43) Pub. Date: Mar. 29, 2007

(54) Method of manufacturing application software

(76) Inventor: Nicholas Phelps, Paris (FR)

Correspondence Address: FULBRIGHT & JAWORSKI, LLP, 666 FIFTH AVE, NEW YORK, NY, 10103-3198, US

(21) Appl. No.: 11/237,363

(22) Filed: Sep. 28, 2005

(51) Int. Cl. H04L 9/00

(52) U.S. Cl. 705/51

(57) ABSTRACT

A method for manufacturing an application software by providing data comprising the software content and data comprising at least media serial code specific to the application. The media serial code is used to provide a personalized application software. The method also provides data comprising a primary computer program, which is used to authenticate the media serial code.

### BACKGROUND OF THE INVENTION

The invention provides a method of manufacturing application software. In the context of the present specification, the application software can be contained on a physical support which can be any support able to contain data, for instance an optical disk (CD, DVD), or a USB device, or a card, or it can be sent to the end user via a communication network such as the Internet.

Software piracy is currently a major issue for the computer industry. The number of pirate copies of software being relatively high, software companies have developed several systems or strategies to address such problem.

Some of the existing systems use a licence number, which represents the piece of software and which is provided to the user when he acquires software. During the installation process in his computer, the user must enter this number, called Serial Number, in the computer in order to authenticate the software. These systems have to face several drawbacks in that they use a number which is manipulated by a user, and thus which must not be too long. Consequently, it is relatively easy to decipher it or to find an algorithm allowing the generation of other valid serial numbers.

For improving such systems, remote registration systems are proposed, wherein the user of the piece of software has to register before being allowed to install the piece of software on his computer, or before he can use the software. In this type of system, the user is requested to provide a licence number or some form of product identification, and then is provided with an access key that will be used in the computer when installing or using the piece of software. Such system cannot always be used, because it implies a connection to the Internet, which is not necessarily available when installing the piece of software. It also requires an operation on behalf of the user that is not always well understood and could result in a deterioration of the user experience.

Another solution to avoid piracy is to use a small hardware device, often referred to as a “dongle”, containing a key access, and which must be connected to the intended computer during the installation process or anytime the software runs. This type of device is harder to copy than software, so it offers a better protection, without needing any Internet connection as in the system described above. However, the dongle is mainly used for a limited number of applications, like protecting very expensive packages of software, because the price of the piece of software is increased by the price of the dongle.

The object of the present invention is to provide a method of manufacturing application software overcoming at least some of the aforementioned drawbacks.

### SUMMARY OF THE INVENTION

In accordance with an embodiment of the present invention, a method of manufacturing an application software comprises the steps of: providing data defining the software content, providing data representing at least one code, called Media Serial, specific to the application software, in order to render it personalized, and providing data defining a primary computer program, this program being used for authenticating the Media Serial.

In accordance with the aspect of the present invention, a “personalized” application software is a software containing specific data which is different from one copy of the software to another. This specific data, called Media Serial, can be used for securing software. Thus, in one embodiment, the Media Serial is comprised of a sufficient number of symbols to defeat most deciphering attempts.

In accordance with an embodiment of the present invention, the personalized application software is sent to the end user via a communication network such as the Internet, and in another embodiment the data is written on a physical support. The physical support can be any support able to contain data, like for example optical disks, USB devices, or cards.

The Media Serial is a long code which depends on the personalized application software, and which is unique. This Media Serial is never communicated to the user, so it can be chosen as long as necessary to prevent from deciphering, without risking any mistake or unpleasant experience for the user when entering it. This method of manufacturing is really an efficient way to avoid pirate copy, because when copying the piece of software, the Media Serial will be copied at the same time, thus the unauthorized copy will be detected very easily in that the Media Serial will no longer be unique. Moreover, in the case where the data is written on a physical support, this method of manufacturing does not require a lot of change in the manufacturing process, so it will not involve any extra cost.

A primary computer program is also provided for authenticating the Media Serial, and, in some embodiments, for generating a Product Installation Code (PIC). This PIC is shorter than the Media Serial, and thus can be manipulated more easily by a user. This PIC can be used for example during communications with the software provider to refer to the product owned by the user. This PIC is generated in such a way that it contains enough information to allow the provider to reconstruct the complete Media Serial.

In an accordance with an embodiment of the present invention, the primary computer program is used for authenticating a Serial Number provided by a user, and uses this Serial Number, possibly in combination with the Media Serial, for generating the Product Installation Code, which is shorter than the Media Serial and which contains enough information to allow the reconstruction of the Serial Number and possibly the Media Serial.

Everyone utilizing regularly a computer is used to enter a Serial Number when installing a new piece of software on his computer. Thus, in one embodiment, the Serial Number utilization is kept in order not to change the user's habits. This Serial Number can also be used, with the Media Serial or alone, to generate the Product Installation Code, and, as explained above, the PIC is generated in such a way that the software provider is able to decipher it and to get the Media Serial and the Serial Number.

In accordance with an embodiment of the present invention, the primary computer program also uses information about the system and/or the user to generate the PIC.

In accordance with an embodiment of the present invention, the PIC contains error-detection or error-recovery data in order to avoid the user entering an invalid PIC in the registration system.

As stated herein, the whole data of the personalized application software may be contained on a physical support. Depending on the embodiment, this physical support can be rewritable and/or recordable. For example it can be a rewritable compact disk or DVD, but also a USB device or a flash memory card.

In accordance with an embodiment of the present invention, the method comprises the step of providing at least one sequence of bits, called marker, used to identify the position of the data representing the Media Serial or any part thereof among the whole data.

In some cases, it can be necessary to locate the Media Serial among all the data, for example for generating the Product Installation Code. A way to do that could be to place the Media Serial always at the same position among the data, but this solution imposes a very high precision during manufacturing, because a single shift in the bits would vitiate the PIC generation. Consequently, in a method according to the invention, the position of the Media Serial is pointed out by a particular sequence of bits, called marker. When the primary computer program needs to find the Media Serial, it reads the data, detects the markers (which can be the same for all personalized software representing the same base software), and then can find the Media Serial.

In accordance with an embodiment of the present invention, several identical markers are provided for the same personalized application software.

In accordance with an embodiment of the present invention, each sequence of data representing a Media Serial or any part thereof is preceded and/or followed by a marker.

In accordance with an embodiment of the present invention, the software is written on a physical support and the Media Serial is provided in the following manner: providing a sequence of bits, called Standard Sequence, which size is the same as the size of the Media Serial, and possibly providing one or several markers, parsing the whole data written or to be written on the support to detect the Standard Sequence, replacing the Standard Sequence by the Media Serial specific to the support, and writing the data on the support.

The fact that each physical support contains a specific Media Serial can lead to a complex manufacturing process if the supports must be manufactured individually. In order to avoid this drawback, all the supports are manufactured with the same Media Serial, represented by a sequence of bits called Standard Sequence. Then, the supports are individually modified by replacing the Standard Sequence by the specific Media Serial of the support at the time of manufacturing.

In another case, for example when using recordable supports, the file containing the personalized application software is modified, by replacing the Standard Sequence, before each recording. In this way, each support will contain a unique Media Serial.

The detection of the markers is a time-consuming operation. Thus, it may be performed only once per software (production batch), for the first copy, and the position of the markers is stored by the software provider. Then, for subsequent copies, the parsing of the data may only consist of checking that the markers are still present at the previously stored position.

In the case where the personalized application software is online, the Media Serial is provided in the following similar manner: providing a sequence of bits, called Standard Sequence, which size is the same as the size of the Media Serial, and providing at least one marker, and replacing the Standard Sequence, identified by the position of the markers, by the Media Serial specific to the personalized piece of software, this step being effected before sending the file to a user.

This allows the software company to keep only one file containing application software, and modifying it each time a user orders one.

Moreover, in most cases, such files represent a large number of bits and it can be useful to compress the data. The compression being a time-consuming operation, the software company can choose to perform it only one time. To do that, in an embodiment, the data is partially or totally compressed, except the data representing the Media Serial which is never compressed. Thus, the software provider can send software with specific Media Serial, without compressing the whole data each time, because it can replace the Media Serial, as explained above and without modifying the compressed data.

In accordance with an embodiment of the present invention, the method comprises the step of providing padding data which is not used by the piece of software, in order to cloak the data representing the Media Serial.

Some pirates may want to find the Media Serial among the whole data of the application software. To this effect, they may analyse the sequence of bits in order to try to generate valid Media Serials on their own. It is the reason why, to avoid this kind of piracy, the invention provides the above mentioned method wherein additional data, called padding data, is added to the data representing software. Their only role is to mislead the pirates who will have to face many unused bits, which are not part of the data defining the software content, without knowing which sequence corresponds to the Media Serial. In one embodiment, this padding data is generated randomly or pseudo-randomly. For example, this padding data can be placed between the markers, forming, with the Media Serial, a long sequence of bits. Thus, even if a pirate detects the marker, he will not know which specific bits of the sequence placed between the markers represent the Media Serial. For example, the Media Serial can be 60 bits long and the total sequence, including the padding data, can be 6000 bits long.

In accordance with an embodiment of the present invention, the data representing the Media Serial is contained in the executable code of the piece of software intended to be installed on a computer, the executable code being replaced by another one each time the piece of software is updated.

The manufacturer of the piece of software can choose to include the Media Serial in the part of the code which is used to execute the program. The advantage of this is to ensure the distribution of the Media Serial with all pirate copies, because even if separate files, like for example license files, may not be distributed by pirates, the application file necessarily is. In the same way, the Media Serial may be contained in other components which are vital to the applications, like for example resources.

In this configuration, the Media Serial will be registered in the computer memory when installing the program, thus it is necessary to be really careful during the updating process, because the update files may replace former code, and then erase the Media Serial from the computer.

In accordance with an embodiment of the present invention, the method comprises the step of providing data defining a secondary computer program, called “launcher”, this program being used, among other purposes, to ensure that the Media Serial remains on the computer on which the piece of software is installed, even after updating the piece of software.

This embodiment is a solution to the aforementioned updating problem. When a user needs to use software installed on a computer, he launches the program, and most of the time, there is an automatic detection of the update files which are ready to be installed. It is the reason why, to prevent from erasing the Media Serial, there is provided the computer program called “launcher”, which is used to realize an interface between the user and the piece of software. Then, the user does not start directly the main program, but starts the “launcher”, that is then in charge of launching the main program. This operation is instantaneous, and thus totally transparent for the user. When an updating file is detected, the launcher analyzes the file and introduces, in it, the Media Serial already present on the computer. To do that, it can for example detect the markers, as seen above. Then, the launcher can allow the installation of the update files, because they contain the Media Serial which will then still be present in the computer of the user.

In accordance with an embodiment of the present invention, to ensure that the Media Serial(s) remain(s) on the computer, the secondary computer program parses the executable code installed on the computer to locate the Media Serial(s), and replaces the files requiring updating, and inserts the Media Serial(s) in the updated files.

As mentioned herein, the Media Serial is preferably long to prevent it from being easily deciphered. Thus, in accordance with an embodiment of the present invention, the length of the Media Serial is more than 60 symbols. The symbols are letters and/or digits and/or other type of symbols.

In accordance with an embodiment of the present invention, a personalized application software is manufactured according to the invention.

In accordance with an embodiment of the present invention, a method for transmitting encrypted data to a software user provides the software content and the following to the user: data representing at least one code, called Media Serial, specific to the personalized application software, and being longer than a predetermined number of symbols in order to prevent the deciphering of the rode, and data defining a primary computer program, this program being used for authenticating the Media Serial and for generating a Product Installation Code from this Media Serial and possibly other data, the Product Installation Code being shorter than the Media Serial, and containing enough information to allow the reconstruction of the Media Serial and/or other data.

The user is registered in a remote registration system with reference to the Product Installation Code corresponding to the personalized application software he owns; and the method comprises the following steps: deciphering the Product Installation Code to get the Media Serial of the personalized application owned by the user, using information contained in the Product Installation Code, such as the Media Serial, to encrypt files to be sent, and transmitting the files to the user.

As soon as a user of a personalized application software is provided with a long code for authenticating the piece of software, this long code can also be used to send encrypted data to the user, after registration on the remote registration system, because the user's computer (and only this computer and/or licensed product) will be able to decipher this data easily.

In accordance with an embodiment of the present invention, the Product Installation Code provided to the user contains error-detection or error-recovery data in order to avoid the user entering an invalid PIC in the registration system.

In accordance with an embodiment of the present invention, the transmitted files are intended to update the piece of software.

In accordance with an embodiment of the present invention, the transmitted files are intended to add functionalities to the piece of software. For example, the transmitted files could provide content for use inside the software (e.g., pictures, sounds, 3D models, etc.).

In this case, the Media Serial can be used to perform online sale. For example, a user may wish to buy an additional toolbox for his piece of software. Then he can order it on a web site of the software provider, and after payment, download the toolbox from this site. The encryption of the file ensures that the file will be used only by the buyer, and not by someone else having the file at his disposal.

In accordance with an embodiment of the present invention, if several Product Installation Codes corresponding to the same Media Serial are registered by different users, the remote registration system detects piracy, and the transmitted data is used to forbid further usage of the application software identified as pirated copies.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the present invention solely thereto, will best be understood in conjunction with the accompanying drawings in which:

FIG. 1 represents the authentication process performed during the installation of a piece of software contained on a support according to the invention;

FIG. 2 represents the transmission of files according to the method of transmitting encrypted data of the invention; and

FIG. 3 represents an example of a sequence of data representing personalized application software according to the invention, the software being written on a physical support.

### DETAILED DESCRIPTION OF THE EMBODIMENTS

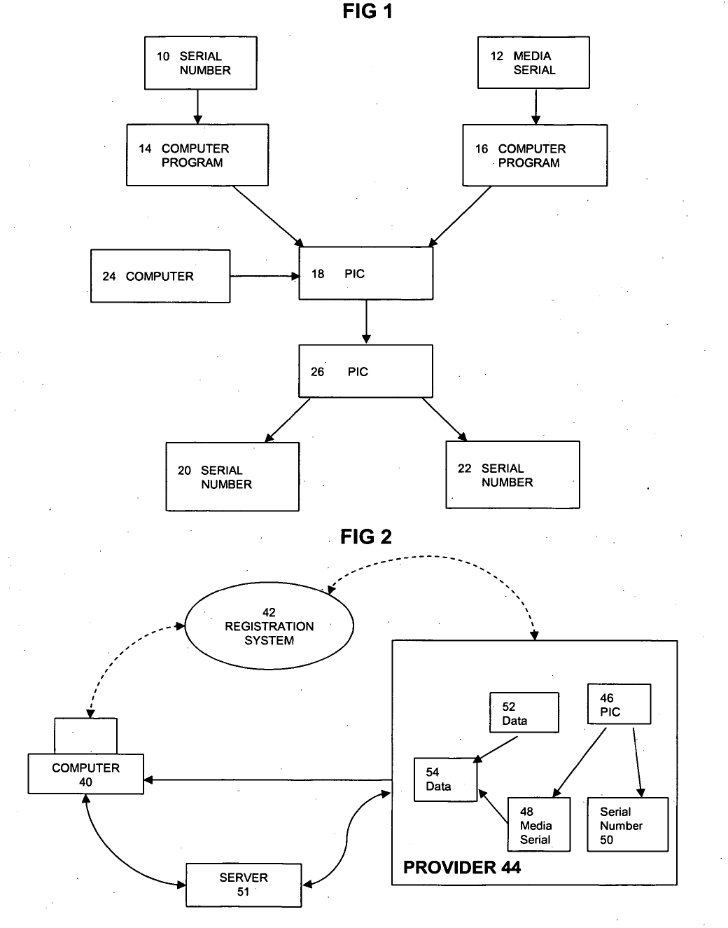

On FIG. 1, a piece of software is to be installed on a computer 24. This piece of software is contained on a physical support which also contains data representing a long code 12 called Media Serial, this code being 60 symbols long. During the installation process, the user who has launched this installation is requested to enter the Serial Number 10 of his product, which is generally about 15 symbols long. The physical support also contains a computer program that is in charge of the validation of these two numbers (respectively 14 for the Serial Number and 16 for the Media Serial). Then, after having authenticated these codes, the program generates a Product Installation Code 18 using the Serial Number 10 and the Media Serial 12. It can also use data representing the computer 24 or the user to generate the PIC. This Product Installation Code, shorter than the Media Serial 12, can be used by the user to identify his product when he wants to deal with the software provider. From the PIC (26), the provider can obtain the Serial Number (20) and the Media Serial (22). For instance, from tables showing the correspondence between PICs and Serial Numbers and Media Serials, are given PIC corresponding to a unique set of Serial Number and Media Serial. From the PIC, the provider can also obtain information concerning the computer on which the piece of software is installed. Then, the user only has to provide a short code, and the provider can identify the product.

On FIG. 2 is represented a system allowing transmission of encrypted files from the software company and a user. If a user wants to use this functionality, he first has to register his software. To do that, he has to connect his computer 40 to a remote registration system 42.

This system 42 asks the user to enter his Product Installation Code, provided by a computer program as seen above.

The remote registration system transfers this PIC 46 to the provider 44 which will analyse it and obtain the Media Serial 48 and the Serial Number 50 of the piece of software.

When the user wants to download a file, like for example an updating file, he connects his computer to a server 51, this server being controlled by the provider.

The server 51 transfers the request of the user to the company 44. The company then selects data 52 to be sent to the user, and encrypts it with a key obtained from the Media Serial 48, and possibly from a Serial Number and other data. Encrypted data 54 are then transmitted to the user's computer. When the file arrives in the computer, it can be deciphered instantaneously because the Media Serial 48 and the possible other data, which have been used to encrypt the file, are also present in the memory of the computer.

The other data used to generate the encryption scheme can be, for example, other system information (e.g., computer Mac addresses, HD numbers), user. information (e.g., name of user) or serial numbers.

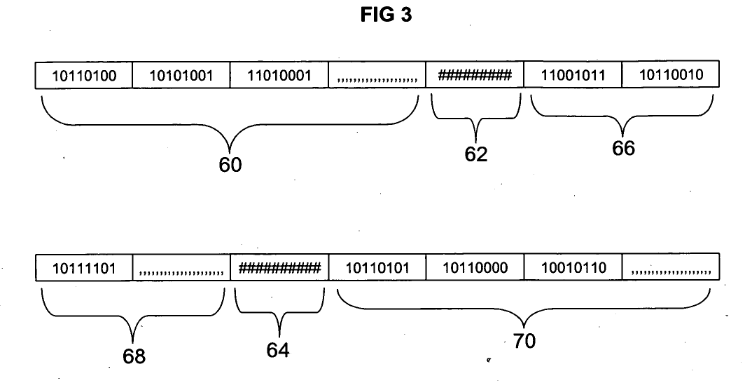

On FIG. 3 can be seen an example of a sequence of data written on a physical support.

This physical support is used to contain application software. The first part 60 of this sequence represents the beginning of the code defining the application software.

Then, the sequence of data contains a first marker 62. This marker is used to point out the position of a Media Serial 66, which is generally very long, about 60 symbols.

In accordance with an embodiment of the present invention, another marker 64 is inserted after the sequence containing the Media Serial to signal the end. In accordance with embodiments of the present invention, only one of the markers 62 and 64 is present; for instance, if the size of the Media Serial is known by another computer program written on the same support, it is sufficient to have one marker signalling the beginning or the end of the Media Serial.

To mislead people who would try to identify the Media Serial, the sequence of data between the markers also contains padding data 68. Padding data are unused in the main program, their only role is to cloak the Media Serial, and so the size of this sequence 68 is not important.

After the second marker, the sequence of data contains data 70 representing a primary computer program used for authenticating the Media Serial.

The sequence of data represented here is only a part of the whole data present on a physical support. On the rest of the support there can be other parts of the code defining the application software, other markers, other padding data, but also data defining other programs, like for example a “launcher”.

In accordance with an embodiment of the present invention, a recordable medium comprises code for manufacturing an application software. The code comprises instructions for: providing data comprising the software content of the application software; providing data comprising at least a media serial code specific to said application software to personalize the application software, thereby providing a personalized application software; and providing data comprising a primary computer program for authenticating the media serial data.

In accordance with an embodiment of the present invention, a computer readable medium comprises code for transmitting encrypted data to a personalized application software user. The code comprises instructions for: providing the user with data comprising software content, data comprising at least a media serial code specific to a personalized application software, and data comprising a primary computer program for authenticating said media serial code and generating a product installation code (PIC) from said media serial code. The media serial code is longer than a predetermined number of symbols to prevent deciphering. The PIC is shorter than the media serial code and comprises sufficient information to permit reconstruction of the media serial code. The code further comprises instructions for registering the user with a remote registration system with reference to the PCI corresponding to the personalized application software owned by said user; deciphering the PIC to obtain the media serial code of the personalized application software owned by the user; encrypting files to be sent to the user using information contained in the PIC and media serial code; and transmitting the encrypted files to said user.

It will be understood that other and further improvements and changes can be made to the exemplary embodiments disclosed herein without departing from the spirit and scope of the present invention.

1. A method of manufacturing an application software, comprising the steps of:
providing data comprising the software content of said application software;
providing data comprising at least a media serial code specific to said application software to personalize said application software, thereby providing a personalized application software; and
providing data comprising a primary computer program for authenticating said media serial data.

2. The method of claim 1, further comprising the step of providing said media serial code comprising a sufficient number of symbols to substantially defeat deciphering attempts.

3. The method of claim 1, further comprising the step of generating a product installation code by said primary computer program from said media serial code, said product installation code being shorter than said media serial code and comprising sufficient information to permit reconstruction of said media serial code.

4. The method of claim 1, further comprising the steps of authenticating a serial number provided by a user and generating a product installation code by said primary computer program from either said serial number or a combination of said serial number and said media serial code, said product installation code comprising sufficient information to permit reconstruction of at least one of the following: said serial number and said media serial code.

5. The method of claim 4, wherein the step of generating comprises the step of generating said product installation code by said primary computer program from information relating to a registration system and/or said user.

6. The method of claim 1, further comprising the step of providing said personalized application software online to end users via a communication network.

7. The method of claim 6, further comprising the step of partially or totally compressing data, except said media serial code, sent online to said end users.

8. The method of claim 1, further comprising the step of storing all of said data on one of the following: a physical support, a recordable physical support or a rewritable physical support.

9. The method of claim 1, further comprising the step of providing a marker comprising at least one sequence of bits for identifying the position of said media serial code.

10. The method of claim 9, further comprising the step of providing said marker at least before or after said media serial code.

11. The method of claim 9, further comprising the step of writing all of said data on a physical support; and wherein the step of providing said media serial code comprises the steps of:
providing a standard sequence comprising a sequence of bits, wherein said standard sequence is the same size as the size of said media serial code;
parsing all of said data written or to be written on said physical support to detect said standard sequence;
replacing said standard sequence with said media serial code specific to said physical support; and
writing said medial serial code on said physical support.

12. The method of claim 11, further comprising the step of providing said personalized application software online to end user via a communication network; and wherein the step of providing said media serial code comprises the step of:
providing a standard sequence comprising a sequence of bits, wherein said standard sequence is the same size as the size of said media serial code; and
replacing said standard sequence, identified by the position of said marker, with said media serial code specific to a physical support before providing said personalized application software online to said end users.

13. The method of claim 1, comprising the step of providing padding data which is not used by said personalized application software to cloak said media serial code.

14. The method of claim 13, further comprising the step of generating said padding data randomly or pseudo-randomly.

15. The method of claim 1, further comprising the step of providing said media serial code embedded in an executable code of software to be installed on a computer.

16. The method of claim 15, comprising the step of providing a secondary computer program for ensuing that said media serial code remains on said computer on which said software is installed, even when components or files of said software are replaced by updates.

17. The method of claim 16, further comprising the steps of parsing said executable code installed on said computer to locate said media serial code, replacing said files to be updated, and inserting said media serial code in said updated files.

18. The method of claim 1, further comprising the step of providing said media serial code comprising at least 60 symbols.

19. A method for transmitting encrypted data to a personalized application software user, comprising the steps of:
providing said user with data comprising software content;
providing said user with data comprising at least a media serial code specific to a personalized application software, said media serial code being longer than a predetermined number of symbols to prevent deciphering;
providing said user with data comprising a primary computer program for authenticating said media serial code and generating a product installation code (PIC) from said media serial code, said PIC being shorter than said media serial code and comprising sufficient information to permit reconstruction of said media serial code;
registering said user with a remote registration system with reference to said PCI corresponding to said personalized application software owned by said user;
deciphering said PIC to obtain said media serial code of said personalized application software owned by the user;
encrypting files to be sent to the user using information contained in said PIC and media serial code; and
transmitting said encrypted files to said user.

20. The method of claim 19, further comprising the step of generating PIC which comprises error-detection or error-recovery data to minimize the entry of an invalid PIC in said remote registration system by said user.

21. The method of claim 19, further comprising the step of updating a software owned by said user using said transmitted files.

22. The method of claim 19, further comprising the step of adding functionalities to a software owned by said user using said transmitted files.

23. The method of claim 19, further comprising the steps of detecting piracy by said remote registration system when several PICs corresponding to the same media serial code are registered by different users and prohibiting further usage of software identified as pirated copies using said transmitted files.

24. A recordable medium comprising code for manufacturing an application software, said code comprising instructions for:
providing data comprising the software content of said application software;
providing data comprising at least a media serial code specific to said application software to personalize said application software, thereby providing a personalized application software; and
providing data comprising a primary computer program for authenticating said media serial data.

25. A computer readable medium comprising code for transmitting encrypted data to a personalized application software user, said code comprising instructions for:
providing said user with data comprising software content;
providing said user with data comprising at least a media serial code specific to a personalized application software, said media serial code being longer than a predetermined number of symbols to prevent deciphering;
providing said user with data comprising a primary computer program for authenticating said media serial code and generating a product installation code (PIC) from said media serial code, said PIC being shorter than said media serial code and comprising sufficient information to permit reconstruction of said media serial code;
registering said user with a remote registration system with reference to said PCI corresponding to said personalized application software owned by said user;
deciphering said PIC to obtain said media serial code of said personalized application software owned by the user;
encrypting files to be sent to the user using information contained in said PIC and media serial code; and
transmitting said encrypted files to said user.
